(19) United States
(12) Patent Application Publication
(10) Pub. No.: US 2022/0100904 A1
(43) Pub. Date: Mar. 31, 2022

(54) COMPUTER IMPLEMENTED METHOD FOR ANALYZING CONTENT ON A VIRTUAL PLATFORM

(71) Applicant: Billy David TEA, Woburn, MA (US)

(72) Inventor: Billy David TEA, Woburn, MA (US)

(21) Appl. No.: 17/033,355

(22) Filed: Sep. 25, 2020

(51) Int. Cl. G06F 21/64; G06Q 30/00; G06Q 50/26; G06F 16/951; G06F 16/23; G06F 16/9538; G06F 3/0481

(52) U.S. Cl. CPC G06F 21/64; G06Q 30/0185; G06Q 50/26; G06F 3/04817; G06F 16/2365; G06F 16/9538; G06F 16/951

(57) ABSTRACT

The present invention relates to a computer implemented method for analyzing content on a virtual platform, the method includes selecting a desired clause from a first template on the virtual platform, wherein the desired clause include a text and/or an image; rendering an icon in a proximity of the selected desired clause, wherein the icon is programmed to transit from the first template to a second template; clicking the icon to analyze the selected desired clause; executing a tamperproof search for analyzing the selected desired clause, wherein executing includes crawling of databases to retrieve the source code; and populating relevant results and highlighting the authentication with domain and/or internet protocol address.

### FIELD OF INVENTION

The present invention generally relates to securing virtual platforms and/or online platforms. More particularly the present invention relates to systems and methods for analyzing content on virtual platforms and validating from the source.

### BACKGROUND OF THE INVENTION

This section is intended only to provide background information pertaining to the similar field of the present invention, and may be used only to enhance the understanding of the present invention and not as admissions of prior art.

In recent past, computing platforms and/or virtual platforms have developed globally. Furthermore, developments include digitisation of day to day processes such as delivery of products, news, information, gatherings in virtual platforms and the like. With the advent of photography and audio recording, additional media have become available for transmitting information and ideas. The information in such media, however, is static. Updated information is provided only by preparing and distributing additional media. However, widespread distribution of updated information, including comments, supplements, features, thoughts, insights, etc., becomes difficult when the information is authored by multiple parties. Media consumers having additional information or insight typically do not have a way to effectively share that information with other consumers.

Furthermore, developments on sharing of information have given rise to fraudulent websites, applications to scam and mislead the actual information. However, there are website blocking applications to block the fraudulent and/or scam websites but such application are inefficient in vanishing or evaluating the chip-in information provided on applications or webpages.

Therefore, in light of foregoing discussion there is a need to overcome the limitations with conventional techniques to secure the digital and/or virtual site from fake or fraudulent information.

### SUMMARY OF INVENTION

In light of the limitations of the existing conventional systems as discussed above, it is evident that there arises a need of an efficient method to overcome the limitations with conventional techniques to secure the digital and/or virtual site from fake or fraudulent information.

Embodiments of the present disclosure provide a computer implemented method for analyzing content on a virtual platform. The method includes selecting a desired clause from a first template on the virtual platform, wherein the desired clause includes a text and/or an image; rendering an icon in a proximity of the selected desired clause, wherein the icon is programmed to transit from the first template to a second template; clicking the icon to analyze the selected desired clause; executing a tamperproof search for analyzing the selected desired clause, wherein executing includes crawling of databases to retrieve the source code; populating relevant results and highlighting the authentication with domain and/or internet protocol address. Furthermore, the desired clause is a web address, a video, a software application, and a combination thereof. In an embodiment, the virtual platforms include internet browser, webpage, mobile application, and a combination thereof. Moreover, the relevant results are in annotation format. Furthermore, executing includes processing of the selected desired clause into a plurality of parameters, wherein the plurality of parameters includes at least one of a authenticating the selected desired clause on comparison with governing bodies; validating claimed articles in the selected desired clause from the source; identifying a true value of the selected desired clause from origin of source; and determining a certified acclaimed party to verify at least one of the above. In an embodiment, governing bodies include financial institutions, administration, universities, non-governmental organizations, news agencies, or a combination thereof. In another embodiment, the claimed articles include a product and/or a service. In one embodiment, the origin of source includes a company, an industry and a combination thereof. Furthermore, the certified acclaimed party includes owner of a company, an industry and a combination thereof.

In an exemplary embodiment, the present disclosure provides a computer program product embodied on a computer readable medium.

### BRIEF DESCRIPTION OF DRAWINGS

The drawing/s mentioned herein disclose exemplary embodiments of the claimed invention. Detailed description and preparation of well-known compounds/substances/elements are omitted to not unnecessarily obscure the embodiments herein. Other objects, features, and advantages of the present invention will be apparent from the following description when read with reference to the accompanying drawing.

FIG. 1 illustrates a computer implemented method for analyzing content on a virtual platform according to an embodiment herein.

### DETAILED DESCRIPTION

This section is intended to provide explanation and description of various possible embodiments of the present invention. The embodiments used herein, and the various features and advantageous details thereof are explained more fully with reference to non-limiting embodiments illustrated in the accompanying drawing/s and detailed in the following description. The examples used herein are intended only to facilitate understanding of ways in which the embodiments may be practiced and to enable the person skilled in the art to practice the embodiments used herein. Also, the examples/embodiments described herein should not be construed as limiting the scope of the embodiments herein.

The present invention relates to a computer implemented method for analyzing content on a virtual platform. Furthermore, the content may be available on a website as a product image and/or a link to be clicked to reach the shopkeeper or manufacturer's address. Moreover, embodiments of the present disclosure provides a one point solution for mitigating the problem of duplicity, fake, fraud of the webpages and/or digital contents,

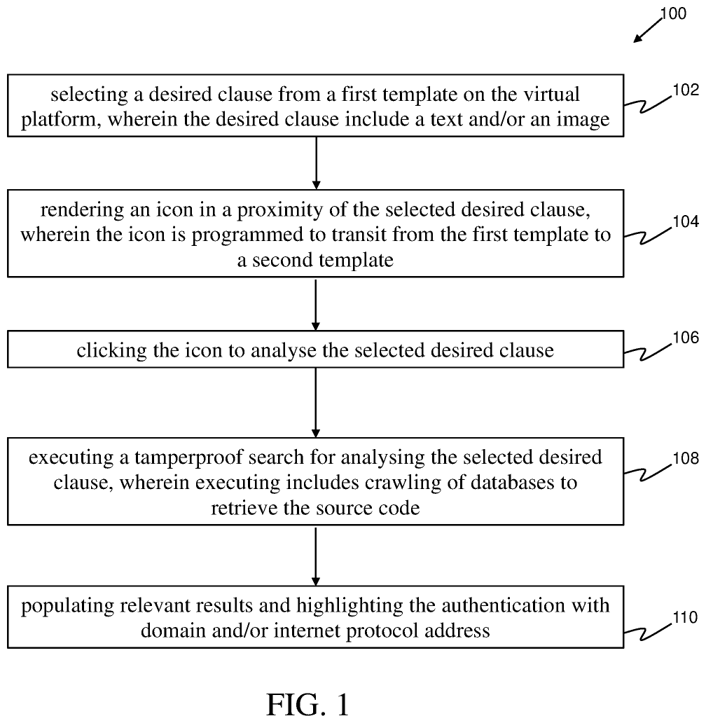

FIG. 1 illustrates a computer implemented method (100) for analyzing content on a virtual platform according to an embodiment herein.

At a step (102) a desired clause is selected from a first template on the virtual platform, wherein the desired clause include a text and/or an image

At a step (104), an icon is rendered in a proximity of the selected desired clause, wherein the icon is programmed to transit from the first template to a second template

At a step (106) the icon is clicked to analyze the selected desired clause

At a step (108) a tamperproof is executed search for analyzing the selected desired clause, wherein executing includes crawling of databases to retrieve the source code

At a step (110) relevant results are populated and highlighting the authentication with domain and/or internet protocol address.

Furthermore, the desired clause is a web address, a video, a software application, and a combination thereof. In an embodiment, the virtual platforms include internet browser, webpage, mobile application, and a combination thereof. Moreover, the relevant results are in annotation format. Furthermore, executing includes processing of the selected desired clause into a plurality of parameters, wherein the plurality of parameters includes at least one of a authenticating the selected desired clause on comparison with governing bodies; validating claimed articles in the selected desired clause from the source; identifying a true value of the selected desired clause from origin of source; and determining a certified acclaimed party to verify at least one of the above. In an embodiment, governing bodies include financial institutions, administration, universities, non-governmental organizations, news agencies, or a combination thereof. In another embodiment, the claimed articles include a product and/or a service. In one embodiment, the origin of source includes a company, an industry and a combination thereof. Furthermore, the certified acclaimed party includes owner of a company, an industry and a combination thereof.

As will be readily apparent to a person skilled in the art, the present invention may easily be produced in other specific forms without departing from its essential composition and properties. The present embodiments should be construed as merely illustrative and non-restrictive and the scope of the present invention being indicated by the claims rather than the foregoing description, and all changes which come within therefore intended to be embraced therein.

1. A computer implemented method for analyzing content on a virtual platform, the method comprising:
selecting a desired clause from a first template on the virtual platform, wherein the desired clause includes a text and/or an image;
rendering an icon in a proximity of the selected desired clause, wherein the icon is programmed to transit from the first template to a second template;
clicking the icon to analyze the selected desired clause;
executing a tamperproof search for analyzing the selected desired clause, wherein executing includes crawling of databases to retrieve the source code; and
populating relevant results and highlighting the authentication with domain and/or internet protocol address.

2. A computer implemented method as claimed in claim 1, wherein the desired clause is a web address, a video, a software application, and a combination thereof.

3. A computer implemented method as claimed in claim 1, wherein, the virtual platform include internet browser, webpage, mobile application, and a combination thereof.

4. A computer implemented method as claimed in claim 1, wherein the relevant results are in annotation format.

5. A computer implemented method as claimed in claim 1, wherein executing includes processing of the selected desired clause into a plurality of parameters, wherein the plurality of parameters includes at least one of:
authenticating the selected desired clause on comparison with governing bodies;
validating claimed articles in the selected desired clause from the source;
identifying a true value of the selected desired clause from origin of source; and
determining a certified acclaimed party to verify at least one of the above.

6. A computer implemented method as claimed in claim 5, wherein governing bodies include financial institutions, administration, universities, non-governmental organizations, news agencies, or a combination thereof.

7. A computer implemented method as claimed in claim 5, wherein the claimed articles include a product and/or a service.

8. A computer implemented method as claimed in claim 5, wherein the origin of source includes a company, an industry and a combination thereof.

9. A computer implemented method as claimed in claim 5, wherein the certified acclaimed party includes owner of a company, an industry and a combination thereof.

10. A computer program product embodied on a non-volatile computer readable medium, the computer program product including processing code that, when executed, enable the method of claim 1 to be performed.

11. A computer program product embodied on a non-volatile computer readable medium, the computer program product including processing code that, when executed, enable the method of claim 2 to be performed.

12. A computer program product embodied on a non-volatile computer readable medium, the computer program product including processing code that, when executed, enable the method of claim 3 to be performed.

13. A computer program product embodied on a non-volatile computer readable medium, the computer program product including processing code that, when executed, enable the method of claim 4 to be performed.

14. A computer program product embodied on a non-volatile computer readable medium, the computer program product including processing code that, when executed, enable the method of claim 5 to be performed.

15. A computer program product embodied on a non-volatile computer readable medium, the computer program product including processing code that, when executed, enable the method of claim 6 to be performed.

16. A computer program product embodied on a non-volatile computer readable medium, the computer program product including processing code that, when executed, enable the method of claim 7 to be performed.

17. A computer program product embodied on a non-volatile computer readable medium, the computer program product including processing code that, when executed, enable the method of claim 8 to be performed.

18. A computer program product embodied on a non-volatile computer readable medium, the computer program product including processing code that, when executed, enable the method of claim 9 to be performed.
